(19) United States
(12) Patent Application Publication
(10) Pub. No.: US 2024/0238812 A1
(43) Pub. Date: Jul. 18, 2024

(54) SHOWER DEVICE FOR GENERATING AT LEAST TWO WATER JET PATTERNS

(71) Applicant: Dornbracht AG & Co. KG, Iserlohn (DE)

(72) Inventor: Marc Oehms, Balve (DE)

(21) Appl. No.: 18/397,285

(22) Filed: Dec. 27, 2023

(30) Foreign Application Priority Data
Dec. 27, 2022 (DE) 10 2022 134 865.2

(51) Int. Cl. B05B 1/18; B05B 1/06

(52) U.S. Cl. CPC B05B 1/185; B05B 1/06

(57) ABSTRACT

A shower device for producing at least two water jet patterns, wherein the shower device has a nozzle arrangement for dispensing water with a first group of nozzles for producing a first pattern and/or a second group of nozzles for producing a second pattern, a first shower head, which has the first and/or the second group of nozzles, and a plurality of water supply lines. The nozzle arrangement has a third group of nozzles for producing a third pattern, in that the shower device has a second shower head, which has the third group of nozzles, and at least one further water supply line, via which water can be supplied to the second shower head, and wherein the first shower head and the second shower head are spaced apart from each other at a shower head distance along an, in particular vertical, geometric main axis of the shower device.

### CLAIM OF PRIORITY

This application claims the benefit of German Patent application No. DE 10 2022 134 865.2 filed on Dec. 27, 2022, the disclosure of which is incorporated herein by reference.

### FIELD OF THE TECHNOLOGY

Various embodiments to a shower device for producing at least two water jet patterns, to a method for producing a water jet pattern, and to a shower system with a shower device and a wall, in particular a ceiling.

### BACKGROUND

Shower devices are known in numerous embodiments and embodiment variants both in the private and the commercial sector. Shower devices are used wherever water is to be provided for personal hygiene. The water is provided in the form of water jet patterns by the shower devices, with the water jet patterns of the different shower devices being able to differ significantly. In private households, for example, water jet patterns which are formed from a plurality of individual water jets are regularly produced. In commercial facilities, for example such as in the hotel and wellness sector, there are, by contrast, also often shower devices, which dispense a surge of water as the water jet pattern. In addition to the functional aspect of dispensing water, the focus is frequently also on aesthetics.

A shower device for producing at least one water jet pattern first of all has a nozzle arrangement. The nozzle arrangement permits the dispensing of water and provides, for example, different nozzles, which differ in particular in that they dispense the water in different ways and/or in that the nozzles are arranged in groups of nozzles positioned at different locations. The shower device further comprises a structural arrangement, which constitutes, for example, the supporting and/or stabilizing basic structure of the shower device and, for example, permits the arrangement of the shower device, e.g. on a wall, especially on a ceiling.

The known prior art (KR 2009 0006913 U), on which some embodiments are based, relates to a shower device which has a nozzle arrangement for dispensing water with a first group of nozzles for producing a first water jet pattern and a second group of nozzles for producing a second water jet pattern. The first group of nozzles and the second group of nozzles are part of a shower head which, in the mounted state, is incorporated in a ceiling. A plurality of water supply lines, via which water can be supplied to the shower head, run within the side wall and the ceiling of a shower area.

Although such shower devices have in the meantime become ever more widespread, since, in addition to use simply for personal hygiene, they also permit a shower experience with different water jet patterns, the type of water jet patterns is relatively limited. It is always a challenge, in the design and development of shower devices, especially for the hotel and wellness sector, to produce as many different types of water jet patterns as possible and which also have an aesthetic appearance and thus intensify the shower experience. In the case of the shower device known from KR 2009 0006913 U, the design at least necessitates that the different groups of nozzles dispense the water, at different locations and with a different intensity, but always exclusively in the vertical direction, i.e. in the direction of gravity.

### SUMMARY

The problem on which some embodiments are based is to design and develop the known shower device in such a way that it is optimized with regard to the production of different types of water jet patterns, which at the same time also have an aesthetic appearance.

The above problem is solved by the features described herein.

A consideration that can be essential is to provide a second shower head in addition to the first shower head, which, as part of a nozzle arrangement, has a further group of nozzles, hereinafter referred to as “third” group of nozzles, for producing a further water jet pattern, hereinafter referred to as “third” water jet pattern, and to arrange this second shower head at a shower head distance from the first shower head. If the second shower head is arranged, for example, on a ceiling of the shower area, owing to the spacing, the first shower head is arranged lower than the second shower head, and therefore water of a water jet pattern which is produced by the first shower head emerges at a different height from the shower device than water of a water jet pattern which is produced by the second shower head. If at least two water jet patterns are produced simultaneously with the first and second shower heads, a unique sculptural overall pattern is created.

Another important aspect is that the spacing of the first shower head from the second shower head means that a part of the nozzle arrangement is arranged in such a way that water can emerge spaced from the wall, in particular the ceiling, at unusual locations for the user and/or in unusual directions, as a result of which novel and particularly appealing water jet patterns can be produced. In particular, it is possible to dispense water not only in one direction, for example vertically downwards parallel to the direction of gravity, but also upwards, such that the water of a corresponding water jet pattern describes a curve due to gravity, and this is perceived as being particularly aesthetic.

In detail, it is proposed that the nozzle arrangement has a third group of nozzles for producing a third water jet pattern, in that the shower device has a second shower head, which has the third group of nozzles and with respect to which the first shower head in the mounted state is arranged in particular rigidly, and at least one further water supply line, via which water can be supplied to the second shower head, and in that the first shower head and the second shower head are spaced apart from each other at a shower head distance along an, in particular vertical, geometric main axis of the shower device.

Various embodiments relate to arrangements and orientations of the shower heads, the nozzles and the housing outlet openings of the respective shower head, which make it possible to produce particularly aesthetic water jet patterns and combinations of water jet patterns and to intensify the shower experience. This relates in particular to the arrangement and orientation of the first and second shower head, the nozzles of the first, second and third group of nozzles, the first and second outlet opening of the housing of the first shower head and the at least one third nozzle and an optionally present third outlet opening which is assigned thereto and can be provided in a housing of the second shower head.

Various embodiments define an annular shape of the housing of the first shower head and a resultantly defined flat jet passage opening. A housing that extends as a ring around a jet passage opening creates an aesthetically high-quality design element and also allows the creation of particularly appealing water jet patterns that further enhance the shower experience.

According to various embodiments, each of the group of nozzles and/or the respective water jet pattern can be rotationally symmetrical. Rotational symmetry provides not only an attractive appearance, but also the advantage that the water is discharged and falls particularly uniformly.

Various embodiments relate to a mounting arrangement with a mounting body, which permits the mounting on or in a wall. The mounting arrangement makes it possible for the shower device, in particular with the two shower heads, to be mounted in a simple manner on a wall or ceiling.

According to various embodiments, those water supply lines, which are provided for supplying water to the first shower head, are designed as supply line and spacing units. By means of such elongate spacers, the first shower head is arranged spaced apart from the wall or the ceiling. The spacers have a dual function and are designed both to supply water to the shower head and to fix the shower head in the room. This dual function of the water supply lines can eliminate the need for additional suspension or fastening components for the shower head, and the spacing from the wall or ceiling, as stated, also provides the possibility of dispensing water not only in one direction vertically downwards, but also upwards. In addition, the supply line and spacing units allow an unobtrusive fastening of the shower head and the creation of a seemingly floating design element.

Various embodiments relate to possibilities of distributing the water supplied to the shower device in the shower device and, in particular, of directing it to the first shower head and to the second shower head.

Various embodiments specify special water jet patterns which can also have an effect on one another and further intensify the shower experience.

Various embodiments relate to an illumination arrangement for illuminating at least one of the water jet patterns, as a result of which the shower experience can be intensified in a particular way, in particular when, as per some embodiments, all of the water jet patterns of the different group of nozzles can be directly illuminated in the shower mode.

According to various embodiments, a method for producing a water jet pattern with a shower device is provided.

The essential factor here is that the shower device is designed as proposed.

Reference may be made to all the embodiments of the proposed shower device.

Various embodiments relate to the production of different, particularly aesthetically pleasing water jet patterns.

According to various embodiments, a shower system with a shower device and a wall, in particular a ceiling, to which the shower device is fastened, is provided.

The essential factor here is that the shower device is designed as proposed.

Reference may be made to all the embodiments regarding the proposed shower device and the proposed method.

Various embodiments provide a shower device for producing at least two water jet patterns, wherein the shower device has a nozzle arrangement for dispensing water with a first group of nozzles for producing a first water jet pattern and/or a second group of nozzles for producing a second water jet pattern, a first shower head, which has the first and/or the second group of nozzles, and a plurality of water supply lines, via which water can be supplied to the first shower head, wherein the nozzle arrangement has a third group of nozzles for producing a third water jet pattern, in that the shower device has a second shower head, which has the third group of nozzles and with respect to which the first shower head in the mounted state is arranged in particular rigidly, and at least one further water supply line, via which water can be supplied to the second shower head, and in that the first shower head and the second shower head are spaced apart from each other at a shower head distance along an, in particular vertical, geometric main axis of the shower device.

In various embodiments, the first shower head extends along an, in particular orthogonal, first plane running transversely with respect to the geometric main axis and the second shower head extends along an, in particular orthogonal, second plane running transversely with respect to the geometric main axis, and in that the first plane and the second plane are different from each other. In various embodiments, the first plane and the second plane are spaced apart from each other and/or are parallel along the main geometric axis of the shower device.

In various embodiments, the first group of nozzles has a plurality of first nozzles for dispensing water for the first water jet pattern and/or the second group of nozzles has a plurality of second nozzles for dispensing water for the second water jet pattern, and in that the third group of nozzles has at least one third nozzle for dispensing of water for the third water jet pattern.

In various embodiments, the first nozzles, in particular the first group of nozzles, are arranged on a common first circular path or a common first elliptical path and/or the second nozzles, in particular the second group of nozzles, are arranged on a common second circular path or a common second elliptical path, which in each case runs parallel to the first plane, and in that the at least one third nozzle lies in the second plane and/or dispenses the water for the third water jet pattern orthogonally to the second plane.

In various embodiments, the first shower head has an, in particular annular, housing, in which the first group of nozzles and/or the second group of nozzles are/is accommodated, and in that the housing has an, in particular slot-shaped and/or curved and/or continuous first outlet opening, via which water from the first group of nozzles, in particular from the first nozzles, can be discharged from the inside of the housing to the outside, and/or a second outlet opening, which is formed in particular from a row of holes, via which water from the second group of nozzles, in particular from the second nozzles, can be discharged from the inside of the housing to the outside.

In various embodiments, the first outlet opening and/or second outlet opening in each case runs parallel to the first plane, and in that the at least one third nozzle and/or a third outlet opening, which is assigned thereto, lies in a housing part of the second shower head in the second plane, and/or the at least one third nozzle discharges the water for the third water jet pattern orthogonally to the second plane.

In various embodiments, the annular housing of the first shower head is formed circulating in the circumferential direction about the geometric main axis and extends in a circulating manner around a flat jet passage opening, the cross-sectional shape of which is defined by the annular shape of the housing, and, in some embodiments, that the second group of nozzles or the second nozzles thereof is or are arranged and aligned such that, in the shower mode, the water of the second water jet pattern at least partially, in some embodiments completely, passes through the jet passage opening of the first shower head, and/or in that the second shower head is arranged in relation to the first shower head in such a way that, in the shower mode, the water of the third water jet pattern at least partially, in some embodiments completely, passes through the jet passage opening of the first shower head.

In various embodiments, the first group of nozzles and/or the second group of nozzles and/or the third group of nozzles are/is rotationally symmetrical, and/or in that the first water jet pattern and/or the second water jet pattern and/or the third water jet pattern are/is rotationally symmetrical. In various embodiments, the axes of the rotational symmetries are identical.

In various embodiments, the shower device has a mounting arrangement with an, in particular plate-like, mounting body for mounting on the wall, in particular the ceiling, on which the second shower head is arranged and which at least partially surrounds the second shower head. In various embodiments, mounting body and the first shower head are spaced apart from each other along the main geometric axis of the shower device, and/or in that the mounting body runs parallel to the first plane.

In various embodiments, the first shower head and/or the second shower head are/is rigidly fastened in the mounted state to the mounting body and/or are/is fastened to the wall exclusively via the mounting body.

In various embodiments, the water supply lines, via which water can be supplied to the first shower head, are designed as supply line and spacing units for supplying water to the first shower head and for spacing and fastening the first shower head in relation to the wall, in particular the ceiling, in some embodiments the water supply lines, via which water can be supplied to the first shower head, the first shower head and the second shower head are spaced apart from one another, and/or the first shower head is arranged on the mounting body via the water supply lines, via which water can be supplied to the first shower head.

In various embodiments, the mounting body has at least one water connection for a connecting supply line, which is laid in particular in the wall, and a water distribution structure, and in that the water distribution structure in the mounting body divides the supply of water between the first shower head and the second shower head, in some embodiments the water distribution structure can be switched in such a way that water is supplied either exclusively to the first shower head or exclusively to the second shower head or simultaneously, in particular in adjustable volume flows, to the first shower head and the second shower head.

In various embodiments, in the shower mode, the first group of nozzles produces a radially outer water jet pattern as the first water jet pattern and/or, in the shower mode, the second group of nozzles produces a radially outer water jet pattern as the second water jet pattern, and in that, in the shower mode, the third group of nozzles produces a radially inner water jet pattern as the third water jet pattern, in some embodiments the first water jet pattern and/or the second water jet pattern fall/falls radially, in particular in an arc, in the direction of the third water jet pattern and/or the third water jet pattern falls along the main geometric axis, in particular vertically and/or rectilinearly, in the direction of the first water jet pattern and/or the second water jet pattern. In various embodiments, the first water jet pattern and/or the second water jet pattern intersect/intersects the third water jet pattern.

In various embodiments, the shower device has an illumination arrangement for illuminating at least one of the water jet patterns by light with at least one light source. In various embodiments, all of the water jet patterns of the different groups of nozzles can be directly illuminated via the illumination arrangement in the shower mode. In various embodiments, the illumination arrangement is at least partially integrated in the second shower head in such a way that the light source of the illumination arrangement can be flowed around by the water from the third group of nozzles.

Various embodiments provide a method for producing a water jet pattern with a shower device according to the disclosure.

In various embodiments, a first water jet pattern produced with the shower device is conical, and/or in that a second water jet pattern produced with the shower device is formed in a sinking manner, and/or in that a third water jet pattern produced with the shower device is cylindrical.

Various embodiments provide a shower system with a shower device and a wall, in particular a ceiling, to which the shower device is fastened, wherein the shower device is designed according to the disclosure.

### BRIEF DESCRIPTION OF THE DRAWINGS

Various aspects are explained in more detail below with reference to a drawing merely illustrating exemplary embodiments. In the drawing

FIG. 1 shows a schematic illustration of a proposed shower system with a proposed shower device in perspective view from below,

FIG. 2 shows a sectional view of the shower device according to FIG. 1 in the shower mode, and

FIG. 3 shows a sectional view, orthogonal to the sectional view in FIG. 2, of a first shower head of the shower device according to FIG. 1.

### DETAILED DESCRIPTION

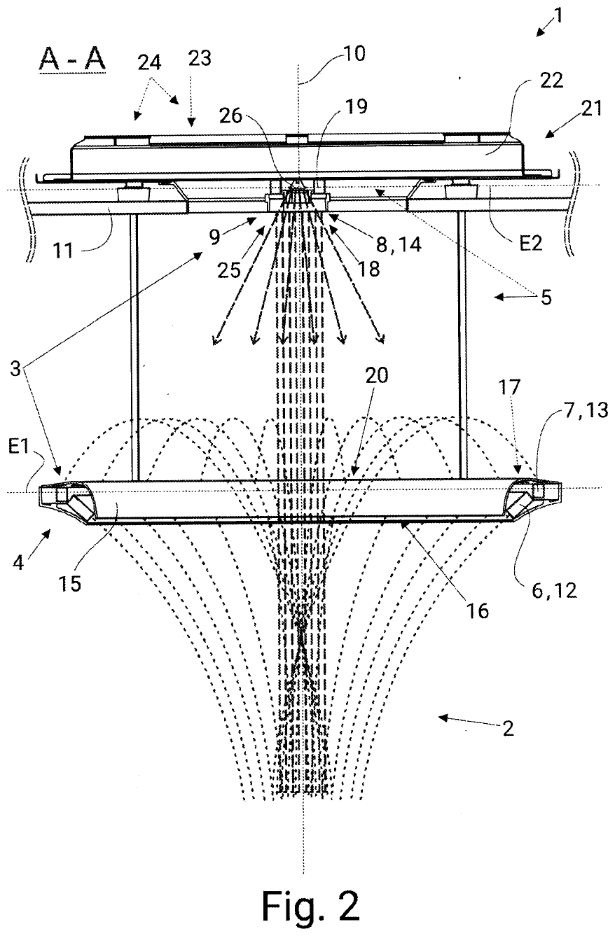

The exemplary embodiment which is illustrated in the figures relates to a shower device 1 for producing at least two water jet patterns 2. The water jet patterns 2 may include, for example, water jets and/or a water surge, as illustrated by way of example in FIG. 2. The water jet patterns 2 can be produced simultaneously or successively in the shower mode.

The shower device 1 has a nozzle arrangement 3, a first shower head 4 accommodating a part of the nozzle arrangement 3, and a plurality of water supply lines 5.

The nozzle arrangement 3 now has a first group of nozzles 6 and/or a second group of nozzles 7 and permits the dispensing of water via them. By means of the first group of nozzles 6, a first water jet pattern 2 can be produced, and/or, by means of the second group of nozzles 7, a second water jet pattern 2 can be produced. It is depicted by way of example in FIG. 2 that the first group of nozzles 6 produces a, in some embodiments conical, first water jet pattern 2 and the second group of nozzles 7 produces a second water jet pattern 2, such as formed in a sinking manner.

A “first” group of nozzles 6 does not mean that another, “second” group of nozzles 7 absolutely also has to be provided on the first shower head 4, and vice versa. On the contrary, the “first” group of nozzles 6 or the “second” group of nozzles 7 may also be the only group of nozzles of the first shower head 4. As will also be further explained, in the present exemplary embodiment, however, two groups of nozzles are provided as part of the first shower head 4.

The first group of nozzles 6 and the second group of nozzles 7 are accommodated by the first shower head 4. The first shower head 4, in various embodiments, can be annular and circular. Other forms are also conceivable, such as annular and elliptical.

Water can be supplied to the first shower head 4 via some of the water supply lines 5. These water supply lines 5, in various embodiments, are in each case tubular. These water supply lines 5, in various embodiments, are in each case rectilinear at least in sections. Furthermore, these water supply lines 5, in various embodiments, have a constant outer diameter, in each case at least in sections, in particular in a visible region.

It is now essential that the nozzle arrangement 3 has a third group of nozzles 8 for producing a third water jet pattern 2, that the shower device 1 has a second shower head 9, which has the third group of nozzles 8, and at least one further water supply line 5, via which water can be supplied to the second shower head 9, and that the first shower head 4 and the second shower head 9 are spaced apart from each other at a shower head distance along an, in particular vertical, geometric main axis 10 of the shower device 1.

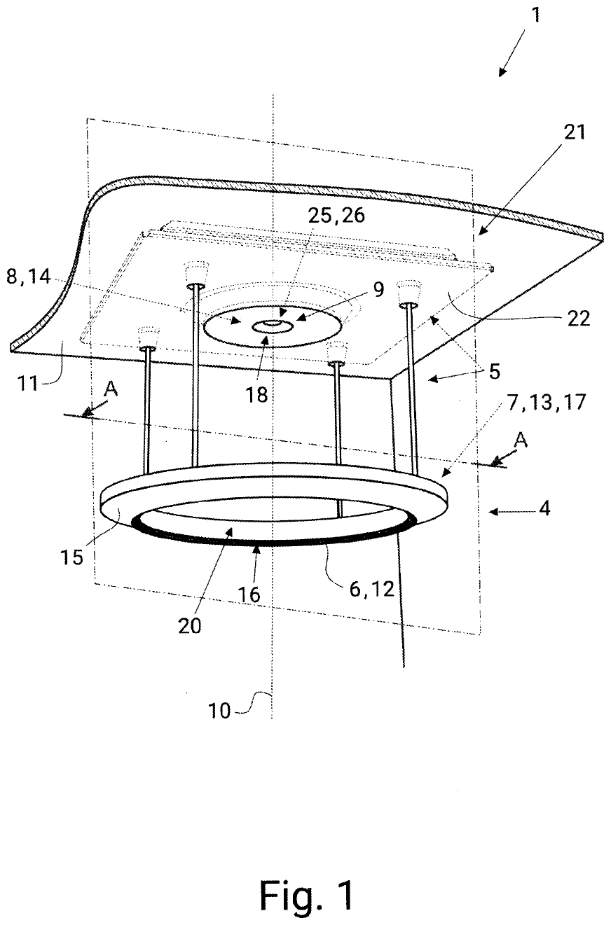

Thus, the nozzle arrangement 3 has at least one further group of nozzles, the third group of nozzles 8, which is not accommodated by the first shower head 4. The second shower head 9, as is apparent from FIG. 1 and FIG. 2, can be fastened to a wall 11, in particular to a ceiling, and/or, in the mounted state of the shower device 1, is arranged closer to the wall 11 and/or ceiling than the first shower head 4.

A wall 11 is very generally meant here to mean any delimitation of the shower area. In particular, the term “wall” 11 here also includes the ceiling of a shower area. A ceiling can for instance be the ceiling of a bathroom or, for example, a suspended ceiling. Where a wall 11 is mentioned below, in the present exemplary embodiment the ceiling is meant. In principle, however, the present disclosure is also applicable to a side wall.

At this juncture, it should be noted that a “third” group of nozzles 8 does not mean here that two additional groups of nozzles absolutely have to be provided in the shower device 1. As previously explained, it is also conceivable that only one single additional group of nozzles, the “first” group of nozzles 6 or the “second” group of nozzles 7, may be provided. The only essential factor is that the “third” group of nozzles 8 is part of the second shower head 9 and at least one other group of nozzles is part of the first shower head 4. As will also be further explained below, in the present exemplary embodiment, however, as stated, a second group of nozzles 7 is also provided as part of the first shower head 4, and therefore a total of three group of nozzles are provided.

In the illustrated exemplary embodiment, a second shower spray 9 is thus provided in addition to the first shower spray 4, which, as part of the nozzle arrangement 3, has a further group of nozzles, the third group of nozzles 8, for producing a further water jet pattern 2, the third water jet pattern 2. This second shower head 9 is arranged at a shower head distance from the first shower head 4. Owing to the spacing, in various embodiments, the first shower head 4 is arranged lower in the vertical direction than the second shower head 9, and therefore water of the water jet patterns 2, which are produced by the first shower head 4, emerges at a higher point from the shower device 1 than water of the water jet pattern 2, which is produced by the second shower head 9, as a result of which, as shown in FIG. 2, a unique sculptural overall pattern is created.

By means of the spacing of the first shower head 4 from the second shower head 9 and/or from the wall 11, it is also possible for water to be able to emerge spaced from the wall 11 and/or ceiling at different locations and/or in different directions, for example even describing an arc due to gravity, as a result of which aesthetically particularly attractive water jet patterns 2 can be produced.

In various embodiments, the first shower head 4 in the mounted state is rigidly arranged with respect to the second shower head 9 and/or with respect to the wall 11. In this context, “rigid” means immovable, that is to say, during a shower mode as intended, the first shower head 4 is not movable with respect to the wall 11 and/or with respect to the second shower head 9, unlike, for example, a hand-held shower. However, the term “rigid” refers only to the mounted state as intended of the shower device 1, which therefore does not exclude adjustability during the mounting, in particular in order to change the shower spacing.

In various embodiments, the first shower head 4 extends along a first plane E1 running transversely with respect to the geometric main axis 10. In order to create the aforementioned shower head distance, in various embodiments the second shower head 9 extends along a second plane E2 running transversely with respect to the geometric main axis 10. The first plane E1 and the second plane E2 are different from each other, wherein the first plane E1 and the second plane E2 can be spaced apart from each other and/or are parallel along the main geometric axis 10 of the shower device 1. The direction transversely with respect to the main geometric axis 10 runs obliquely or orthogonally to the main geometric axis 10.

Furthermore, in various embodiments, it is provided that the first group of nozzles 6 has a plurality of first nozzles 12 for dispensing water for the first water jet pattern 2 and/or the second group of nozzles 7 has a plurality of second nozzles 13 for dispensing water for the second water jet pattern 2. According to FIG. 1 and FIG. 2, the third group of nozzles 8 has an individual third nozzle 14 or also a plurality of third nozzles 14 for dispensing water for the third water jet pattern 2.

It should also be noted that a group of nozzles, for example the third group of nozzles 8, does not absolutely have to have a plurality of nozzles, but may also have only one individual nozzle. In the case of the first group of nozzles 6 and the second group of nozzles 7, however, a plurality of nozzles are in each case provided.

The first nozzles 12 and/or the second nozzles 13 and/or the at least one third nozzle 14 may be formed as surge nozzles and/or as jet nozzles, to name just a few examples. In the exemplary embodiment according to FIG. 2, the nozzles are designed as jet nozzles.

Furthermore, in various embodiments, water can be dispensed in a first direction via the first nozzles 12 and water can be dispensed in a second direction via the second nozzles 13, and the first direction is different from the second direction.

In the present context, “different” means that the two directions differ from each other, in particular the first direction differs by at least 30°, by at least 60°, or by at least 90°, from the second direction.

Furthermore, it can be conceivable that the first direction is oriented downwards with respect to a horizontal plane E1, E2 and the second direction is oriented upwards with respect to the horizontal plane E1, E2, as is apparent by way of example from FIG. 2. It is possible for the water of the second water jet pattern 2 to undergo a change in direction due to gravity. Also illustrated by way of example in FIG. 2, the first water jet pattern 2 is conical and the second water jet pattern 2 is formed in a sinking manner.

It is illustrated here that the first nozzles 12, in particular the first group of nozzles 6, are arranged on a common first circular path or a common first elliptical path, and/or the second nozzles 13, in particular the second group of nozzles 7, are arranged on a common second circular path or a common second elliptical path. In various embodiments, the first circular path or first elliptical path and the second circular path or second elliptical path are arranged concentrically, and/or the diameters of the first circular path and the second circular path or the main and secondary axes of the first elliptical path and the second elliptical path differ in size. The respective common circular or elliptical path runs parallel to the first level E1. Furthermore, the at least one third nozzle 14 lies in the second plane E2 and/or dispenses the water for the third water jet pattern 2 orthogonally to the second plane E2.

Furthermore, in various embodiments, it is provided that the first shower head 4 has a housing 15 in which the first group of nozzles 6 and/or the second group of nozzles 7 are/is at least partially, in particular completely, accommodated. It can be provided that the housing 15 has an, in particular slot-shaped and/or curved and/or continuous, first outlet opening 16, via which water from the first group of nozzles 6, in particular from the first nozzles 12, can be discharged from the inside of the housing 15 to the outside. In addition or alternatively, it can be provided that the housing 15 has a second outlet opening 17 which is formed in particular from a row of holes, i.e., from holes arranged in a row, via which water from the second group of nozzles 7, in particular from the second nozzles 13, can be discharged from the inside of the housing 15 to the outside. As shown in FIGS. 1 to 3, this housing 15, in various embodiments, is annular, in particular circular or elliptical.

The first outlet opening 16 should be understood as being “slot-shaped” if the ratio of its length to its width is at least 20 to 1, at least 45 to 1, or at least 60 to 1.

In various embodiments, the first outlet opening 16 and/or the second outlet opening 17 in each case runs parallel to the first plane E1. Furthermore, as in the present exemplary embodiment, the at least one third nozzle 14 can lie in the second plane E2. In addition or alternatively, a third outlet opening 18 which is assigned to the at least one third nozzle 14 may also be located in a housing part 19 of the second shower head 9 in the second plane E2. In addition or alternatively, as illustrated by way of example in FIG. 2, the at least one third nozzle 14 can also dispense the water for the third water jet pattern 2 orthogonally to the second plane E2.

It is also provided, in various embodiments, that the here annular housing 15 of the first shower head 4 is formed circulating in the circumferential direction about the geometric main axis 10 and extends in a circulating manner around a flat, i.e. not annular, jet passage opening 20, the cross-sectional shape of which is defined by the annular shape of the housing 15 and to this extent is in particular circular or elliptical.

In various embodiments, the second group of nozzles 7 or the second nozzles 13 thereof are arranged and aligned such that, in the shower mode, the water of the second water jet pattern 2 at least partially, in some embodiments completely, passes through the jet passage opening 20 of the first shower head 4. In addition or alternatively, it may also be provided that the second shower head 9 is arranged relative to the first shower head 4 such that, in the shower mode, the water of the third water jet pattern 2 at least partially, in some embodiments completely, passes through the jet passage opening 20 of the first shower head 4. This can be seen by way of example from FIG. 2. In this context, “completely” does not include spray or misdirected water from defective or dirty nozzles or the like, but rather refers only to the intended water jet pattern 2 in regular operation.

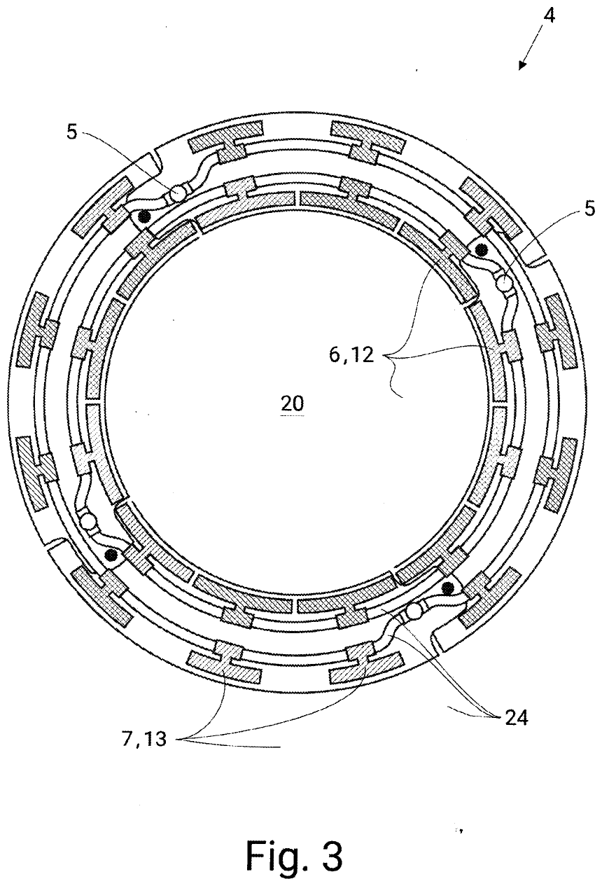

Furthermore, in various embodiments, it is provided that the first group of nozzles 6 and/or the second group of nozzles 7, as illustrated by way of example in FIG. 3, and/or the third group of nozzles 8 is rotationally symmetrical. In addition or alternatively, as illustrated by way of example in FIG. 2, the first water jet pattern 2 and/or the second water jet pattern 2 and/or the third water jet pattern 2 can also be rotationally symmetrical, with the axes of the rotational symmetries, in various embodiments, being identical.

In the illustrated embodiment, it is furthermore the case that the shower device 1 has a mounting arrangement 21 with an, in particular plate-like, mounting body 22 for mounting on the wall 11, in particular the ceiling, on which the second shower head 9 is arranged and which at least partially surrounds the second shower head 9. In various embodiments, the mounting body 22 and the first shower head 4 can be spaced apart from each other along the main geometric axis 10 of the shower device 1, and/or in that the mounting body 22 runs parallel to the first plane E1. As shown by way of example in FIG. 1, it is conceivable that the mounting body 22 is mounted on a ceiling of a bathroom and a suspended ceiling runs below the mounting body 22.

The first shower head 4 and/or the second shower head 9 can be rigidly fastened in the mounted state to the mounting body 22 and/or are/is fastened to the wall 11 exclusively via the mounting body 22.

Furthermore, in various embodiments, it is provided that the water supply lines 5, via which water can be supplied to the first shower head 4, are designed as supply line and spacing units for supplying water to the first shower head 4 and for the spacing and fastening of the first shower head 4 in relation to the wall 11, in particular the ceiling. In this way, the nozzle arrangement 3 can be placed in the shower area during the mounting in such a way that water can emerge spaced from the wall 11 and/or ceiling at different locations and/or in different directions. In addition, the supply line and spacing units permit the production of a seemingly floating design element, which makes the overall aesthetic effect of the shower device 1 particularly attractive.

In various embodiments, the water supply lines 5, via which water can be supplied to the first shower head 4, space the first shower head 4 and the second shower head 9 with respect to each other. The shower spacing can be at least 20 cm, at least 30 cm, or at least 45 cm. The first shower head 4 and the second shower head 9, in various embodiments, are arranged coaxially to each other.

In addition or alternatively, as shown by way of example in FIG. 1 and FIG. 2, the first shower head 4 can be arranged on the mounting body 22 via the water supply lines 5, via which water can be supplied to the first shower head 4.

In various embodiments, the water supply lines 5, via which water can be supplied to the first shower head 4, are arranged substantially parallel to one another. In various embodiments, the water supply lines 5 are the same length and/or have the same diameter. It is possible for the water supply lines 5 to be oriented vertically, that is to say, in the direction of gravity, as is illustrated by way of example in FIGS. 1 and 2. Alternatively or in addition, the water supply lines 5 are arranged on a common first circular path, as can be seen by way of example from FIG. 3, or on a common elliptical path.

In various embodiments, as an overall view of FIG. 2 and FIG. 3 shows, the water supply lines 5, via which water can be supplied to the first shower head 4, are divided into water supply lines groups 5, here into two water supply lines groups 5, wherein each water supply line group 5 supplies water to another group of nozzles. Water can be supplied to the first group of nozzles 6 via a first water supply line group 5 with at least two water supply lines 5 and water can be supplied to the second group of nozzles 7 via a second water supply line group 5 with at least two water supply lines 5. In this case, the first water supply line group 5 and the second water supply line group 5 are formed separately from each other in terms of flow, in various embodiments, in such a way that the water supply lines 5 of the first water supply line group 5 and the water supply lines 5 of the second water supply line group 5 are arranged substantially parallel to one another and/or on a common third circular path or elliptical path.

When supplying the first and second group of nozzles 7 with water via in each case two water supply lines 5, a larger volume flow of water can be supplied to the corresponding group of nozzles than would be the case, for example, with a single water supply line 5. In particular in cases in which the first group of nozzles 6 and/or the second group of nozzles 7, for example, have a large number of first nozzles 12 or second nozzles 13, it is possible to ensure a uniform supply of water via the majority of the water supply lines 5 of each water supply line group 5, without for example having to accept unnecessarily high pressure losses. Water can be supplied separately to the respective group of nozzles by being supplied via water supply lines 5, which are formed separately from one another in terms of flow.

It is also provided, in various embodiments, that the mounting body 22 has at least one water connection 23 for a connecting line, which is laid in particular in the wall 11, and a water distribution structure 24, and that the water distribution structure 24 in the mounting body 22 divides the supply of water between the first shower head 4 and the second shower head 9. The water distribution structure 24 can be switchable, namely in such a way that water is supplied either exclusively to the first shower head 4 or exclusively to the second shower head 9 or simultaneously, in particular in adjustable volume flows, to the first shower head 4 and the second shower head 9.

As can be seen from FIG. 2, it is also provided, in the present exemplary embodiment, that, in the shower mode, the first group of nozzles 6 produces a radially outer water jet pattern 2 as the first water jet pattern 2 and/or, in the shower mode, the second group of nozzles 7 produces a radially outer water jet pattern 2 as the second water jet pattern 2, and that, in the shower mode, the third group of nozzles 8 produces a radially inner water jet pattern 2 as the third water jet pattern 2.

A “radially outer” water jet pattern 2 means that the water for the water jet pattern 2 emerges from the shower head, here the first shower head 4, relatively far radially on the outside, with reference to the geometric main axis 10. Accordingly, a “radially inner” water jet pattern 2 means that the water for the water jet pattern 2 emerges from the shower head, here the second shower head 9, radially further inside than in the case of the radially outer water jet pattern 2, with reference to the geometric main axis 10.

In various embodiments, it is the case that the first water jet pattern 2 and/or the second water jet pattern 2 fall/falls radially, in particular in an arc, in the direction of the third water jet pattern 2 and/or the third water jet pattern 2 falls along the main geometric axis 10, in particular vertically and/or rectilinearly, in the direction of the first water jet pattern 2 and/or the second water jet pattern 2. As shown by way of example in FIG. 2, the first water jet pattern 2 and/or the second water jet pattern 2 here intersect/intersects the third water jet pattern 2.

It is further provided, in various embodiments, that the shower device 1 has an illumination arrangement 25 for illuminating at least one of the water jet patterns 2 by light having at least one light source 26. In various embodiments, all of the water jet patterns 2 of the different groups of nozzles can be illuminated directly via the illumination arrangement 25 in the shower mode. In the present exemplary embodiment, the illumination arrangement 25 is at least partially integrated in the second shower head 9 in such a way that the light source 26 of the illumination arrangement 25 can be flowed around by the water from the third group of nozzles 8.

A method for producing a water jet pattern 2 with a proposed shower device 1 is proposed.

Reference may be made to all the embodiments of the proposed shower device 1.

Furthermore, in various embodiments, it is provided that a first water jet pattern 2 produced with the shower device 1 is conical, and/or that a second water jet pattern 2 produced with the shower device 1 is formed in a sinking manner, and/or in that a third water jet pattern 2 produced with the shower device 1 is cylindrical. In various embodiments, the water jet patterns 2 can be formed from a water surge and/or from a plurality of individual water jets.

In FIG. 2, by way of example, the first water jet pattern 2 is conical and formed from a plurality of individual water jets, and/or the second water jet pattern 2 is formed in a sinking manner and from a plurality of individual water jets, and/or the third water jet pattern 2 is cylindrical and formed from a circulating water surge.

Also proposed is a shower system with a shower device 1 and a wall 11, in particular a ceiling, to which the shower device 1 is fastened. In FIG. 1, an exemplary embodiment of the shower system is depicted by way of example.

It is further provided, in various embodiments, that the shower device 1 is designed as proposed.

Reference may be made to all the embodiments regarding the proposed shower device 1 and the proposed method.

1. A shower device for producing at least two water jet patterns, wherein the shower device comprises a nozzle arrangement for dispensing water with a first group of nozzles for producing a first water jet pattern and/or a second group of nozzles for producing a second water jet pattern, a first shower head, which comprises the first and/or the second group of nozzles, and a plurality of water supply lines, via which water can be supplied to the first shower head,
wherein the nozzle arrangement comprises a third group of nozzles for producing a third water jet pattern, wherein the shower device comprises a second shower head, which comprises the third group of nozzles and with respect to which the first shower head in the mounted state is arranged, and at least one further water supply line, via which water can be supplied to the second shower head, and wherein the first shower head and the second shower head are spaced apart from each other at a shower head distance along a geometric main axis of the shower device.

2. The shower device according to claim 1, wherein the first shower head extends along an first plane running transversely with respect to the geometric main axis and the second shower head extends along a second plane running transversely with respect to the geometric main axis, and wherein the first plane and the second plane are different from each other.

3. The shower device according to claim 1, wherein the first group of nozzles comprises a plurality of first nozzles for dispensing water for the first water jet pattern and/or the second group of nozzles comprises a plurality of second nozzles for dispensing water for the second water jet pattern, and wherein the third group of nozzles comprises at least one third nozzle for dispensing of water for the third water jet pattern.

4. The shower device according to claim 3, wherein the first nozzles are arranged on a common first circular path or a common first elliptical path and/or the second nozzles are arranged on a common second circular path or a common second elliptical path, which in each case runs parallel to the first plane, and wherein the at least one third nozzle lies in the second plane and/or dispenses the water for the third water jet pattern orthogonally to the second plane.

5. The shower device according to claim 1, wherein the first shower head comprises a housing, in which the first group of nozzles and/or the second group of nozzles are/is accommodated, and wherein the housing comprises a first outlet opening, via which water from the first group of nozzles can be discharged from the inside of the housing to the outside, and/or a second outlet opening, which is formed from a row of holes, via which water from the second group of nozzles can be discharged from the inside of the housing to the outside.

6. The shower device according to claim 5, wherein the first outlet opening and/or second outlet opening in each case runs parallel to the first plane, and wherein the at least one third nozzle and/or a third outlet opening, which is assigned thereto, lies in a housing part of the second shower head in the second plane, and/or the at least one third nozzle discharges the water for the third water jet pattern orthogonally to the second plane.

7. The shower device according to claim 5, wherein the housing of the first shower head is formed circulating in the circumferential direction about the geometric main axis and extends in a circulating manner around a flat jet passage opening, the cross-sectional shape of which is defined by an annular shape of the housing.

8. The shower device according to claim 1, wherein the first group of nozzles and/or the second group of nozzles and/or the third group of nozzles are/is rotationally symmetrical, and/or wherein the first water jet pattern and/or the second water jet pattern and/or the third water jet pattern are/is rotationally symmetrical.

9. The shower device according to claim 1, wherein the shower device comprises a mounting arrangement with a mounting body for mounting on the wall, on which the second shower head is arranged and which at least partially surrounds the second shower head.

10. The shower device according to claim 7, wherein the first shower head and/or the second shower head are/is rigidly fastened in the mounted state to the mounting body and/or are/is fastened to the wall exclusively via the mounting body.

11. The shower device according to claim 1, wherein the water supply lines, via which water can be supplied to the first shower head, are designed as supply line and spacing units for supplying water to the first shower head and for spacing and fastening the first shower head in relation to the wall.

12. The shower device according to claim 1, wherein the mounting body comprises at least one water connection for a connecting supply line, which is laid in the wall, and a water distribution structure, and wherein the water distribution structure in the mounting body divides the supply of water between the first shower head and the second shower head.

13. The shower device according to claim 1, wherein, in the shower mode, the first group of nozzles produces a radially outer water jet pattern as the first water jet pattern and/or, in the shower mode, the second group of nozzles produces a radially outer water jet pattern as the second water jet pattern, and wherein, in the shower mode, the third group of nozzles produces a radially inner water jet pattern as the third water jet pattern, wherein the first water jet pattern and/or the second water jet pattern fall/falls radially in the direction of the third water jet pattern and/or the third water jet pattern falls along the main geometric axis in the direction of the first water jet pattern and/or the second water jet pattern.

14. The shower device according to claim 1, wherein the shower device comprises an illumination arrangement for illuminating at least one of the water jet patterns by light with at least one light source.

15. A method for producing a water jet pattern with a shower device according to claim 1.

16. The method according to claim 15, wherein a first water jet pattern produced with the shower device is conical, and/or wherein a second water jet pattern produced with the shower device is formed in a sinking manner, and/or wherein a third water jet pattern produced with the shower device is cylindrical.

17. A shower system with a shower device and a wall to which the shower device is fastened,
wherein the shower device is designed according to claim 1.

18. The shower device according to claim 2, wherein the first plane and the second plane are spaced apart from each other and/or are parallel along the main geometric axis of the shower device.

19. The shower device according to claim 7, wherein the second group of nozzles or the second nozzles thereof is or are arranged and aligned such that, in the shower mode, the water of the second water jet pattern at least partially passes through the jet passage opening of the first shower head, and/or in that the second shower head is arranged in relation to the first shower head in such a way that, in the shower mode, the water of the third water jet pattern at least partially passes through the jet passage opening of the first shower head.

20. The shower device according to claim 8, wherein the axes of the rotational symmetries are identical.
